(19) United States
(12) Patent Application Publication
(10) Pub. No.: US 2007/0266749 A1
(43) Pub. Date: Nov. 22, 2007

(54) Pesticidal compositions for treating anthropods and methods for the use thereof

(76) Inventors: Jason Rader, Marysville, OH (US); Shannon Hollis, Delaware, OH (US); Casey McDonald, Galloway, OH (US)

Correspondence Address: James B. Raden, 22nd Floor, 120 South Riverside Plaza, Chicago, IL, 60606-3912, US

(21) Appl. No.: 11/801,441

(22) Filed: May 10, 2007

Related U.S. Application Data
(60) Provisional application No. 60/800,531, filed on May 15, 2006.

(51) Int. Cl. A01G 1/04

(52) U.S. Cl. 71/5

(57) ABSTRACT

A composition and method for causing arthropod mortality utilize a formulation containing at least one surfactant selected from a defined group to cause the dynamic surface tension of the formulation to be less than about 30 dynes per centimeter as measured with a Kruss Bubble Pressure Tensiometer (BP2 Version 1.20) causing more than 80% mortality of the treated arthropods within about two minutes or less after the arthropods are treated with the composition.

### CROSS-REFERENCE TO RELATED APPLICATION

This application claims priority to Provisional Application No. 60/800,531, filed May 15 2006, which is incorporated herein in its entirety.

### BACKGROUND OF THE INVENTION

1. Field of the Invention

The present invention relates generally to pesticidal formulations containing surfactants and to methods for the use thereof. More particularly, the formulations of the present invention contain surfactants enabling the formulations to exhibit surface tension levels which cause improved pesticidal efficacy of treated arthropods.

2. Description of Related Art

Pesticidal formulations can be in the form of solutions, emulsions, suspensions, dispersions and the like, and are used in agriculture for applying agricultural chemicals to plants, soil, insects and the like. Among typical pesticidal chemicals are herbicides, insecticides, fungicides, growth regulators and the like.

Such formulations have been known to contain surfactants such as trisiloxane surfactants and other surfactants to enhance the physical characteristics of the formulation for treating pests such as by improving the spreading thereof when the formulation is applied in agriculture.

However, prior pesticidal formulations including those employing surfactants therein have not been sufficiently effective for causing quick kill of arthropods treated therewith. As used herein the term “quick kill” means a period of time of two minutes or less to achieve “mortality” of treated arthropods.

The term arthropod as employed herein means any invertebrate of the phylum Arthropoda including insects, spiders and other arachnids, crustaceans, myriapods and various household pests. For purposes hereof, cockroaches are specifically to be considered to fall within the definition of arthropods.

The deficiency in speed of kill achieved with prior art pesticidal formulations is significant and there has been an on going need in the consumer market for liquid insecticidal ready-to-use products, which provide fast and effective mortality rates of treated arthropods and, in particular, quick kill attributes. For example, known formulations often require as much as one-quarter hour or more to achieve acceptable mortality levels against difficult to control pests, such as American cockroaches (Periplaneta americana).

Thus, it would be advantageous to provide pesticidal formulations containing surfactants which provide improved mortality rates in the order of 80% or greater within about two minutes or less, after treatment of the pests including difficult to control pests such as cockroaches.

It would also be advantageous to provide pesticidal formulations containing surfactants which enable the formulation to have a dynamic surface tension as measured with a Kruss Bubble Pressure Tensiometer (BP2 Version 1.20) which provides enhanced mortality rates (quick kill) of arthropods treated with the formulations.

In particular, it would be advantageous to provide formulations which contain surfactants, such as certain trisiloxane surfactants, and suitable other surfactants which act to reduce the dynamic surface tension of the formulation to a level of less than 30 dynes per centimeter as measured with a Kruss Bubble Pressure Tensiometer (BP2 Version 1.20) whereby a mortality rate of more than about 80% of treated arthropods is achieved within about two minutes or less after treatment.

### SUMMARY OF THE INVENTION

Accordingly, it is an object of the present invention to provide compositions wherein the surfactant portion enables a dynamic surface tension level as measured with a Kruss Bubble Pressure Tensiometer (BP2 Version 1.20) of the formulation sufficient to cause a desired mortality rate of arthropods including difficult to control arthropods such as cockroaches.

Another object is to provide stable pesticidal products for treatment of arthropods such as agricultural formulations containing certain surfactants such as trisiloxane surfactants that provide improved rapid arthropod mortality when applied directly to the arthropods.

In particular, it is an object to provide compositions containing at least one surfactant which causes the dynamic surface tension of the composition to be at a level of less than about 30 dynes per centimeter as measured with a Kruss Bubble Pressure Tensiometer (BP2 Version 1.20) whereby treatment of arthropods with the composition causes more than about 80% mortality of the treated arthropods within about two minutes or less after the arthropods are treated with the composition.

### DETAILED DESCRIPTION OF THE INVENTION

In accordance with the present invention, a composition is provided for causing arthropod mortality in which the composition comprises a formulation containing at least one surfactant which causes the dynamic surface tension of the formulation to be at a level of less than about 30 dynes per centimeter as measured with a Kruss Bubble Pressure Tensiometer (BP2 Version 1.20) whereby a quick kill rate of more than about 80% mortality of arthropods treated with the formulation is achieved within about two minutes or less, after the arthropods are treated with the composition.

The at least one surfactant in the compositions of the present invention is preferably selected from the group consisting of trisiloxane, ethoxylated acetylenic diol and pyrrolidone surfactants and mixtures thereof.

In a preferred embodiment, the at least one surfactant in the composition is a trisiloxane surfactant selected from the group consisting of:

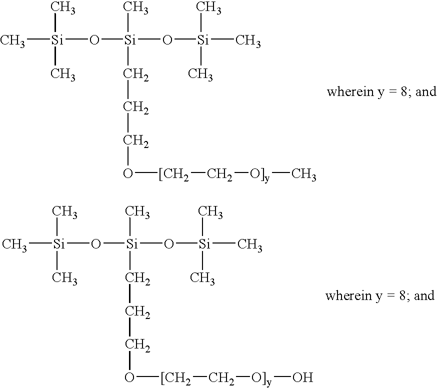

mixtures thereof.

In further preferred embodiments, the at least one surfactant is selected from the group consisting of 2,5,8,11 tetramethyl 6 dodecyn-5,8 diol ethoxylate; ethoxylated 2,4,7,9-tetramethyl 5 decyn-4,7-diol; mixed alkylpyrrolidones; sulfuric acid monododecyl ester sodium salt; polyether modified polysiloxane surfactants and mixtures thereof.

In the compositions and methods of the present invention, the at least one surfactant is present in the formulation in a sufficient concentration to cause the dynamic surface tension level of the formulation as measured with a Kruss Bubble Pressure Tensiometer (BP2 Version 1.20) to be less than about 30 dynes per centimeter. In a preferred embodiment, the surfactant is present at a concentration of about 0.1 weight percent to about 1.0 weight percent.

It is most preferred that the at least one surfactant in the composition is selected from the group consisting of Silwet L-77® (General Electric Company, Waterford, N.Y.); and Silwet REACH®, also known as Silwet 408® (General Electric Company, Waterford, N.Y.); and mixtures thereof.

As a result of the unexpected rapid mortality rates (quick kill) achieved in treating arthropods when the noted surfactants are present in the compositions of the present invention at a concentration sufficient to cause the dynamic surface tension of the composition to be at a level of less than about 30 dynes per centimeter as measured with a Kruss Bubble Pressure Tensiometer (BP2 Version 1.20), it has been found that very effective agricultural products, including liquid pesticidal products, can be provided which will fulfill the need in the consumer market for pesticidal products which provide better mortality rates (quick kill), particularly of difficult to control arthropods.

In general, an agricultural spray mixture contains water and an active agricultural chemical ingredient, such as a pesticide (including herbicides, insecticides, fungicides, growth regulators and the like). Typically, at least 50 percent of a pesticidal spray mixture is composed of water. Optionally, the pesticidal spray mixture can contain at least one component selected from the group consisting of organic surfactants, antifoam agents and organic solvents. Agricultural spray mixtures are commercially available as ready-to-use products or can be prepared in a containment vessel from an agricultural chemical concentrate, water, and optionally one or more surfactants and/or antifoaming agents.

The amount of an active ingredient (i.e., agricultural chemical) in a spray mixture, if used in addition to the at least one surfactant employed in the compositions of the present invention as described above, will be any amount effective for the intended purpose, but typically will range from about 0.001 to about 5 percent by weight based upon the total weight of the agricultural spray mixture (e.g., from about 0.03 percent to about 0.5 percent, preferably from about 0.05 percent to about 0.25 percent based upon the total weight of the agricultural spray mixture). The bulk of the remainder of the agricultural spray mixture is comprised of water.

Surfactants, solvents, biocides, antifoam agents, antifreezes, pH modifiers, colorants, nutrients and plant growth regulators may be included in the formulations to achieve desired results.

To screen the efficacy of pesticides using selected surfactants, and combinations of surfactants, American cockroaches, (Periplaneta americana) known to be difficult to kill, were introduced into 1.5-inch diameter polyvinyl chloride (PVC) pipe sections with stainless steel screens affixed to the bottom end. An automatic pipetter was used to apply 4.8 ml of a composition of this invention to each cockroach. Excess liquid was drained from the tubes through the stainless steel screen. Each cockroach was transferred to a clean polypropylene container where mortality results were recorded 120 seconds after application of the composition. A cockroach is determined to be killed when life functions have ended and movement is no longer observed in the testing container.

Illustrative pesticides which can be employed as an active ingredient in the pesticidal spray mixtures of the present invention, in addition to the at least one surfactant described herein, include those from the groups consisting of herbicides, insecticides, fungicides, miticides and the like.

The following specific example is presented to further illustrate and explain certain aspects of the present invention. However, the example is set forth for illustration only, and is not to be construed as limiting on the present invention. In the following examples, all percentages and parts are by weight unless otherwise specified.

### EXAMPLE

In accordance with this Example, surfactants were tested which enable formulations containing such surfactants to have a dynamic surface tension of less than about 30 dynes per centimeter as measured with a Kruss Bubble Pressure Tensiometer (BP2 Version 1.20) for treatment of American cockroaches and comparisons were made with formulations used for treatment of American cockroaches which contained other surfactants which did not produce formulations exhibiting the required level of dynamic surface tension as measured with a Kruss Bubble Pressure Tensiometer (BP2 Version 1.20).

Based on this testing, it was determined that the following surfactants provide formulations exhibiting a level of dynamic surface tension necessary to accomplish the objectives of the present invention. The most preferred surfactants are products sold under the trademarks: Silwet REACH®, Silwet L-77®, Agrimax® 3 and combinations of Dynol 604 and Surfynol 465.

The chemical structure of Silwet REACH as characterized hereinabove is as follows:

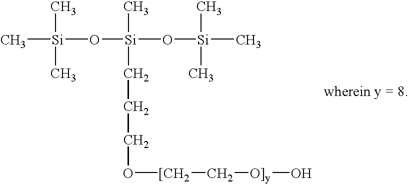

The chemical structure of Silwet L-77 as characterized hereinabove is as follows:

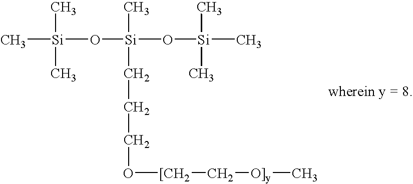

It should be noted that In the chemical structure of the Silwet L-77® and Silwet REACH trisiloxane surfactants the amount of (C₂ H₄O) represents an average.

The chemical description of Dynol 604 is a 2,5,8,11 tetramethyl 6 dodecyn-5,8 diol ethoxylate.

The chemical description of Surfynol 465 is ethoxylated 2,4,7,9-tetramethyl 5 decyn-4,7-diol.

Agrimax® 3 is a water based microemulsion forming system commercially supplied by International Specialty Products containing mixed alkyl pyrrolidones, surfactants and water insoluble polymers.

Surfactants that were tested in this Example which did not provide formulations which exhibit the required level of dynamic surface tension, as measured with a Kruss Bubble Pressure Tensiometer (BP2 Version 1.20), included phosphate esters and alcohol ethoxylates. The products tested are sold under the trademarks TMULZ 1227 (Harcros Chemicals Inc., Kansas City, Kans.) and Ethylan TD-120 (Akzo Nobel Surface Chemistry LLC, Chicago, Ill.).The chemical description for TMULZ 1227 is phosphate ester and the chemical description for Ethylan TD-120 is alcohols, C₁₁₋₁₄ iso-, C₁₃-iso-rich, ethoxylated.

The formulations employed in this example were prepared in accordance with the following procedures:
(i) Formulations 1-10 tabulated below in the Table were prepared by introducing and mixing the specified surfactant/surfactants, at the weight percentages indicated in the Table, into a base composition containing about 0.387 to about 0.389 wt percent of an agriculturally active ingredient such as bifenthrin, (commercially available from FMC Corporation as Talstar MUP, a liquid concentrate containing 13.0% bifenthrin Talstar MUP); about 1.544 to about 1.549 wt percent other inert ingredients and about 98.1214 to about 99.052 wt percent water;
(ii) Formulations 11-13 tabulated below in the Table were not introduced into the base composition but, to the contrary, were prepared by introducing and mixing the specified weight percentages of the surfactant/surfactants in 99 wt percent water, without any other additives; and
(iii) Formulation 14 was a control containing no surfactants or other additive ingredients.

The formulations tested and the results of such testing are set forth in the following Table:

TABLE

| | | Dynamic | | | | |
|---|---|---|---|---|---|---|
| | | Surface Tension | | | | |
| | | (Dynes/cm)* | | | | Mortality |
| | | At Frequency | | | | (mean) |
| | Surfactants in Formulations 1-14 | 2 Hz | 3 Hz | 4 Hz | 5 Hz | 120 SAT** |
| 1 | Silwet REACH + Silwet L-77 (1%) | 22 | 22 | 23 | 24 | 100% |
| 2 | Silwet REACH (1%) | 24 | 25 | 26 | 27 | 100% |
| 3 | Silwet L-77 (1%) | 23 | 24 | 24 | 25 | 100% |
| 4 | Silwet REACH (0.5%) | 25 | 26 | 28 | 29 | 100% |
| 5 | Silwet L-77 (0.5%) | 26 | 27 | 28 | 30 | 80% |
| 6 | Silwet 806 (1%) | 24 | 25 | 27 | 29 | 90% |
| 7 | Dynol 604 + Surfynol 465 (1%) | 26 | 26 | 26 | 27 | 100% |
| 8 | Agrimax 3 (1%) | 29 | 29 | 30 | 30 | 85% |
| 9 | TMulz 1227 (1%) | 31 | 32 | 32 | 33 | 35% |
| 10 | Ethylan TD 120 (1%) | 34 | 35 | 35 | 36 | 35% |
| 11 | Water + Silwet REACH + Silwet L-77 | 21 | 22 | 23 | 24 | 100% |
| | (1%) | | | | | |
| 12 | Water + Silwet REACH (1%) | 21 | 22 | 24 | 25 | 100% |
| 13 | Water + Silwet L-77 (1%) | 21 | 22 | 23 | 24 | 100% |
| 14 | Untreated | | | | | 0% |

*Measured with a Kruss Bubble Pressure Tensiometer (BP2 Version 1.20)
**SAT means seconds after treatment

From the results tabulated above, it should be clear that there is a direct correlation between the dynamic surface tension of the formulation, as measured with a Kruss Bubble Pressure Tensiometer (BP2 Version 1.20), and the level of mortality achieved in treating a difficult to treat arthropod such as the American cockroaches treated herein.

Specifically, the tabulated results demonstrate that the formulations of the present invention including the surfactants which provide a dynamic surface tension of less than about 30 dynes per centimeter as measured with a Kruss Bubble Pressure Tensiometer (BP2 Version 1.20) caused mortality rates of more than about 80% within two minutes (ie, 120 seconds) or less after treatment of the American cockroaches treated herein.

Although the invention has been described in its preferred forms with a certain degree of particularity, it is to be understood that the present disclosure has been made by way of example only. Numerous changes in the details of the compositions and ingredients therein as well as the methods of preparation and use will be apparent without departing from the spirit and scope of the invention, as defined in the appended claims.

What is claimed is:

1. A composition for treating arthropods comprising a formulation containing at least one surfactant enabling the formulation to have a dynamic surface tension level of less than about 30 dynes per centimeter as measured with a Kruss Bubble Pressure Tensiometer (BP2 Version 1.20) causing a mortality rate of more than about 80% within about two minutes or less after treatment of arthropods with the composition.

2. The composition of claim 1, wherein the at least one surfactant is selected from the group consisting of silicone, ethoxylated acetylenic diol and pyrrolidone surfactants and mixtures thereof.

3. The composition of claim 2, wherein the at least one silicone surfactant is a siloxane surfactant.

4. The composition of claim 3, wherein the siloxane surfactant is selected from the group consisting of: 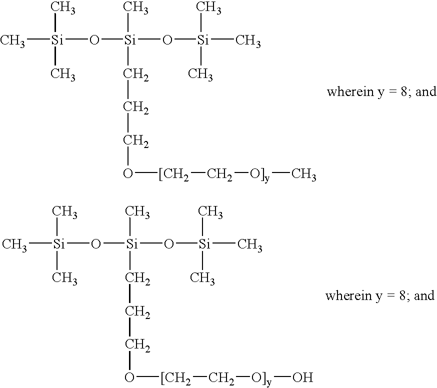
mixtures thereof.

5. The composition of claim 2, wherein the at least one surfactant is selected from the group consisting of 2,5,8,11 tetramethyl 6 dodecyn-5,8 diol ethoxylate; ethoxylated 2,4,7,9-tetramethyl 5 decyn-4,7-diol; mixed alkylpyrrolidones; sulfuric acid monododecyl ester sodium salt; polyether modified polysiloxane and mixtures thereof.

6. The composition of claim 1 wherein, in the absence of any pesticidally active ingredient other than the at least one surfactant, the at least one surfactant is present in the composition in a sufficient concentration to cause the dynamic surface tension level of the formulation to be less than about 30 dynes per centimeter as measured with a Kruss Bubble Pressure Tensiometer (BP2 Version 1.20) to cause more than about 80% mortality of treated arthropods within about two minutes or less after the arthropods are treated with the composition.

7. The composition of claim 1 wherein the at least one surfactant is a silicone surfactant and is present in the composition at a concentration of about 0.1 weight percent to about 1.0 weight percent.

8. A method for treating arthropods comprising:
a) providing a formulation containing at least one surfactant, the formulation having a dynamic surface tension level of less than about 30 dynes per centimeter as measured with a Kruss Bubble Pressure Tensiometer (BP2 Version 1.20); and
b) applying the formulation having the dynamic surface tension level of less than about 30 dynes per centimeter to treated arthropods causing a mortality rate of the treated arthropods of more than about 80% within about two minutes or less after the arthropods are treated with the composition.

9. The method of claim 8, wherein the formulation applied to the arthropods contains at least one surfactant selected from the group consisting of silicone, ethoxylated acetylenic diol and pyrrolidone surfactants and mixtures thereof.

10. The method of claim 9, wherein the silicone surfactant is a siloxane surfactant.

11. The method of claim 10, wherein the siloxane surfactant is selected from the group consisting of: 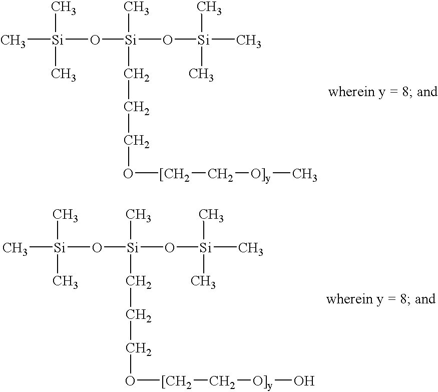
mixtures thereof.

12. The method of claim 8, wherein the at least one surfactant is selected from the group consisting of 2,5,8,11 tetramethyl 6 dodecyn-5,8 diol ethoxylate; ethoxylated 2,4,7,9-tetramethyl 5 decyn-4,7-diol; mixed alkylpyrrolidones; polyether modified polysiloxane and mixtures thereof.

13. The method of claim 8 wherein, in the absence of any pesticidally active ingredient other than the at least one surfactant, the at least one surfactant is present in the composition in a sufficient concentration to cause the dynamic surface tension of the formulation to be at a level of less than about 30 dynes per centimeter as measured with a Kruss Bubble Pressure Tensiometer (BP2 Version 1.20) causing more than about 80% mortality of the treated arthropods within about two minutes or less after the formulation is applied to the treated arthropods.

14. The method of claim 8 wherein the at least one surfactant is a siloxane surfactant and is present in the composition at a concentration of about 0.1 weight percent to about 1.0 weight percent.
